(19) United States
(12) Patent Application Publication
(10) Pub. No.: US 2004/0136434 A1
(43) Pub. Date: Jul. 15, 2004

(54) Laminated heat flux indicating device

(76) Inventor: Lawrence W. Langley, Blacksburg, VA (US)

Correspondence Address: Lawrence W. Langley, 2733 Big Falls Road, Blacksburg, VA, 24060, US

(21) Appl. No.: 10/340,521

(22) Filed: Jan. 13, 2003

(51) Int. Cl. G01K 17/00

(52) U.S. Cl. 374/29

(57) ABSTRACT

Analog electric signals representing convective and total heat transfer into or out of a surface are produced by opposed thermocouple pairs in a laminated assembly comprising a layer of infrared transparent material and a layer of infrared absorbing material. The laminated assembly is attached to the surface with the infrared absorbing layer in thermal contact with the surface. A voltage produced by a first opposed thermocouple pair represents the temperature difference across the infrared transparent layer. A voltage produced by a second opposed thermocouple pair represents the temperature difference across the infrared absorbing layer. Using the known value for thermal resistance of the infrared transparent layer, the temperature difference across this layer is used to calculate convective heat transfer. Using the known value for thermal resistance of the infrared absorbing layer, the temperature difference across this layer is used to calculate the total heat transfer by radiation and convection combined. The radiative heat transfer is then calculated by subtracting the convective heat transfer from the total heat transfer. An alternative construction of the sensor for indicating only convective heat transfer employs an infrared transparent layer with series opposed thermocouples on its two sides.

### BACKGROUND

It is well known to those skilled in the art of heat transfer measuring instrument design that there are three modes of heat transfer; radiation, convection and conduction. Sensors are readily available for each of the three modes, and for certain combinations of the three modes. For example, radiometers have been designed for selective indication of radiative heat transfer. One type of radiometer combines a broad-band heat flux sensing element with a water-cooled window that excludes convective heat transfer to the sensing element. A common approach to the design of a sensor for selective indication of convective heat transfer is to apply a reflective coating to the front surface of a total heat flux sensor. This reduces the response of the sensor to radiation, enabling it to preferentially indicate convective heat transfer.

There are two basic methods for measuring heat flux. In the first method, seldom used in practice, the sensor is a small heat absorbing (black) body such as a solid cylinder, well-insulated from its surroundings and instrumented with one or more thermocouples. When one of its planar end surfaces is exposed to a radiative source, the black body absorbs heat, and its temperature rises. The total heat absorbed by the body can be calculated from the temperature rise, the physical dimensions of the black body, and the specific heat of the material from which it is made. This method for measuring heat flux has the major disadvantage that it can only be used for short time measurements. If the black body is physically small enough to provide good sensitivity to heat flux, then its temperature will rise rapidly. This results in an error caused by convection of heat away from the exposed surface, losses by conduction through the supports and by re-radiation from the surface. The only way to determine an instantaneous value of heat flux from such a sensor is to calculate the time derivative of the temperature rise. This calculation magnifies any electrical noise that has been picked up with the temperature signal. The method cannot be used to measure convective or conductive heat flux because the temperature of the isolated body varies with time, and the heat transfer coefficients for convection and conduction will vary in an unpredictable manner.

The second, more common method for measuring heat flux utilizes a thermal resistance element placed in the path of heat flow, and at least two temperature sensors such as thermocouples. One thermocouple is attached to the thermal resistance element at the location or surface where heat enters. Another thermocouple is attached to the thermal resistance element at the location or surface where heat exits. The two thermocouples are ordinarily connected with their potentials in series opposition to produce a voltage directly indicative of the magnitude and sign of the temperature difference across the thermal resistance element. This arrangement is commonly referred to as a “thermopile”. The thermal resistance element may be a disc, rod or sheet of any thermally conductive material. Heat flux may be calculated from the known thickness and thermal properties of the thermal resistance element material, and the temperature difference across it produced by heat flow. Alternatively, if it is impractical to control or measure the dimensions and material composition of the thermal resistance element well enough for an analytical prediction of the sensor's characteristics, a heat flux sensor of this type may be calibrated after construction by comparing its signal with that of a heat flux standard with similar heat flows.

Sensors employing the thermal resistance method for measuring heat flux may be adapted for measurements of radiative, convective or conductive heat flux. If a sensor of this type is coated on its exposed face with a high emissivity (black) paint, it will indicate the sum of radiant and convective heat flux, or “total” heat flux. This type of sensor is generally called a “total heat flux sensor”, or calorimeter.

To adapt a sensor of this type for indicating only radiative heat flux, one must block convective heat transfer. This is usually done by inserting an infrared transparent window between the radiative source and the sensor. The window is cooled to prevent heat transfer by convection from the inside of the window to the sensor. The sensor is blackened for maximum absorption of radiative heat flux. The resulting instrument is called a radiometer. Transmission characteristics of the window define the spectrum of radiative heat flux that is indicated.

The thermal resistance type of sensor may be adapted to indicate only convective heat flux by covering its front surface with a highly reflective coating. Although a perfectly reflective surface does not exist, the response to radiation can be reduced to 5% or less of the incident heat flux

A thermal resistance type of sensor can be employed to indicate conducted heat flux by placing it in the path of heat flow within a solid object. This is a fairly rare procedure because it is difficult to compensate for the effects of the sensor's presence well enough to achieve accurate measurements.

In many practical situations heat is transferred to an article by a combination of radiation and convection. A particular example of interest is in ovens for cooking food, such as cookies or bread. These ovens conventionally have radiative heating elements that directly heat the food articles by illuminating them with infrared radiation. The atmosphere in the oven is also heated by these heating elements, and it contributes additional heating to the food articles by convection. In these situations it is of great interest to know how much of the heating is the result of radiation and how much is the result of convection. The appearance and quality of the cooked food article may require a specific combination of radiative and convective heating, as well as a specific time profile for each. Thus it would be of great interest to separately indicate radiative and convective heat transfer in such ovens, as functions of position and time in the oven.

While a radiometer and a total heat flux sensor can make simultaneous measurements, they cannot do so simultaneously at the same location. At best they can be placed side-by-side, but the difference between their fields of view and spectral response make comparisons very risky. The total heat flux sensor has a 180° field of view, and the radiometer has a narrower field of view defined by its window and the bezel holding the window in place. The spectral response of the total heat flux sensor is defined by the spectral emissivity of its surface coating, while that of the radiometer is further limited by transmission characteristics of the window.

If an instrument for the simultaneous measurement of radiative and convective heat transfer at a common location could be devised, an important application would be in oven heat transfer profiling. Such an application is clearly described in U.S. Pat. No. 6,264,362, issued to Robert Mitchell Rolston. The system disclosed in this patent has two sensors, one primarily indicating radiative heat transfer, the other primarily indicating total heat transfer. These sensors are mounted on a heat-absorbing carrier in a leading/trailing arrangement along the axis of travel through the oven. The carrier is passed through the oven in the same manner as the product, while recording the output signals of both sensors. During or after passage through the oven, the signal from the leading sensor is delayed by an appropriate amount and then compared with the signal of the trailing sensor to calculate radiative and convective heat transfer. The incorporation of a delay in processing the leading sensor signal assures that the two signals always represent radiative and total heat fluxes at corresponding longitudinal positions in the oven. The delay is based on the speed of travel through the oven, so as to create exact positional correspondence. If the speed of travel varies during recording there will be an error in this compensation process.

An ideal instrument for simultaneous, separate measurements of radiative and convective heat transfer would sense these variables at the same location. Such an instrument is described in the accompanying disclosure and claims.

### BRIEF DESCRIPTION OF THE DRAWINGS

FIG. 1 is a plan view of the laminated sensor and a schematic depicting amplifiers of the invention.

FIG. 2 is a sectional view of the laminated sensor of the invention.

### DETAILED DESCRIPTION OF THE PREFERRED EMBODIMENT

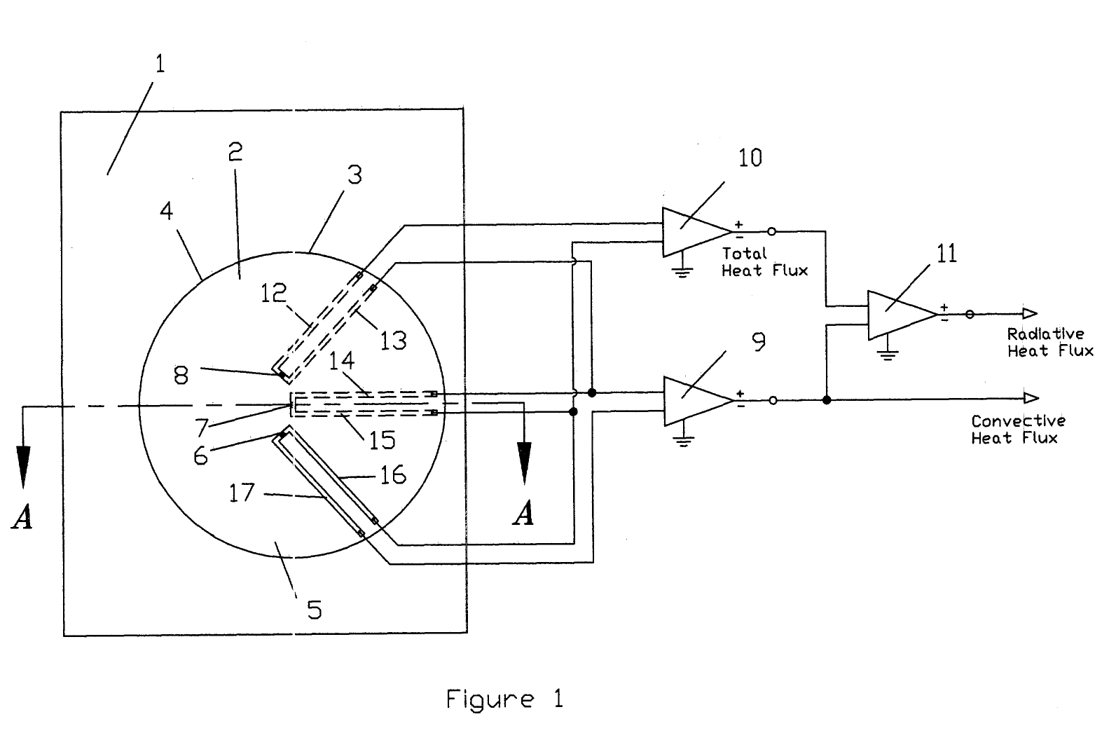

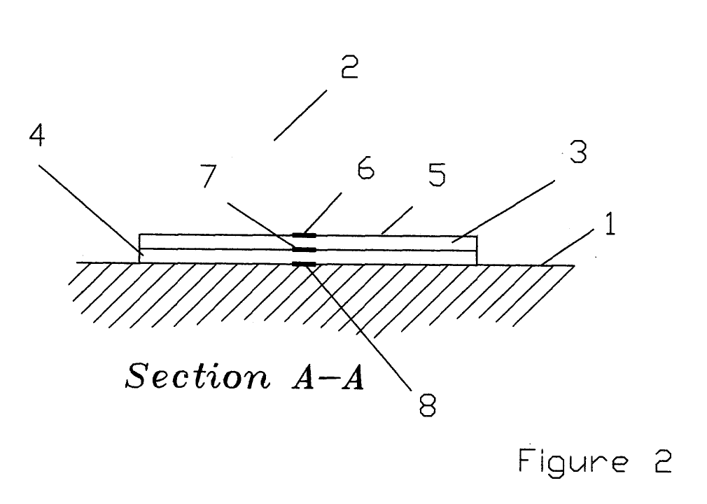

FIG. 1 shows the preferred embodiment of an invention for simultaneous indications of convective, radiative and total heat fluxes at the same location on a surface 1. The invention comprises a laminated sensor 2 adapted for attachment to the surface, together with thermocouples and amplifiers for indicating temperature differences. As shown most clearly in FIG. 2, the laminated sensor has a first thin circular disk 3 of an infrared transparent material such as teflon and a second thin circular disk 4 of an infrared absorbing material such as black vinyl. These disks are nominally of the same diameter. The disks are bonded together and then bonded to the surface 1, with the infrared absorbing disk 4 in direct thermal contact with the surface. Three thin film thermocouples 6, 7 and 8 are deposited on the disks and connected as pairs (thermopiles) with potentials opposed to indicate temperature differences across the thickness of the disks. In the preferred embodiment the thermocouples are copper-constantan types whose area is small compared to that of the circular disks 3 and 4. The copper and constantan conductors of thermocouples 6,7, and 8 extend as narrow leads 12, 13, 14, 15, 16 and 17 to the edges of their respective disks to allow wiring connections. For clarity the thermocouples 6, 7 and 8 are depicted as non-overlapping in FIG. 1, whereas in the preferred embodiment they would all be located near the centers of their respective disks as shown in FIG. 2.

When radiant heat energy impinges on the outer surface 5 of this laminated sensor, most of it passes through the disk of infrared transparent material 3 without being absorbed. The radiant energy is absorbed at the surface of the infrared absorbing disk 4 and produces a temperature rise across this disk that is proportional in magnitude to the radiant heat flux.

Convective heat energy impinging on the outer surface of the infrared transparent disk 3 is absorbed at that surface, and produces a temperature rise across both infrared transparent and infrared absorbing disks 3 and 4. This temperature rise is proportional in magnitude to the convective heat flux.

When the sensor of the invention is illuminated by radiation and also heated or cooled by convection, the temperature rise across the infrared absorbing disk 4 will be the algebraic sum of the temperature rise caused by radiation and the temperature rise or fall caused by convection. The result is a total heat flux indication. The convective heat flux indication provided by the thermocouples on opposite faces of the infrared transparent disk 3 can be used to calculate the radiative component of heat flux under both of these conditions

In a sensor that is properly designed for minimum perturbation of heat flows, the temperature rises and falls produced by convective and radiative heat fluxes are small, so the potentials produced by the thermocouple pairs are also small in magnitude. It is necessary to amplify them and apply scale factors before they can be digitized or recorded. In the preferred embodiment a first amplifier 9 receives the voltage produced by the opposition of potentials of thermocouples 6 and 7 on two sides of the infrared transparent layer 3. A second amplifier 10 receives the voltage produced by opposition of the potentials of thermocouples 7 and 8 on two sides of the infrared absorbing layer 4. Thus the potential of the middle thermocouple 7 is subtracted from that of thermocouple 6 on the outer surface of the infrared transparent disk to indicate the magnitude and direction of convective heat flux. The potential of thermocouple 8 on the inside surface of the infrared absorbing disk is subtracted from the potential of the middle thermocouple 7 to indicate the magnitude of total heat flux. These values are adjusted to the same scale factor by setting the amplifier gains. Finally, the convective heat flux is algebraically subtracted from the total heat flux by a third differential amplifier 11 to indicate the radiative heat flux.

If the thermal properties and thickness of the infrared transparent layer 3 and the relationship between temperature and voltage of the middle and outer thermocouples 6 and 7 are known, the difference in temperature across this layer may be used to calculate the convective heat transfer. If the thermal properties and thickness of the infrared absorbing layer 4 and the relationship between temperature and voltage of the inner and middle thermocouples 7 and 8 are known, the difference in temperature across this layer may be used to calculate the total heat transfer by radiation and convection combined. The radiative heat transfer may then be calculated by subtracting the convective heat transfer from the total heat transfer. In the preferred embodiment, analog differential amplifiers 9, 10 and 11 are used to scale and amplify the heat flux indicating signals. If these signals are to be stored for later analysis, they can be digitized by a multiplexed analog-to-digital convertor (not shown). The values of convective, total and radiative heat flux may then be transmitted to a microprocessor, (also not shown) which would display these values or deliver them to a recording device or controller.

### Features and Advantages of the Preferred Embodiment

The principal feature of the invention is that it indicates convective, radiative and total heat flux simultaneously and at the same location on a surface, with no restriction in the field of view. Whether the sensor is heated by radiation or not, convective heating or cooling will be indicated accurately. The preferred embodiment of the invention uses small area thin film thermocouples on the surfaces of the laminated assembly to indicate the temperatures of these surfaces. These small area thin films add negligible thermal mass to the surfaces and do not significantly change the temperatures they indicate. The thin films of the thermocouple 6 on the front surface 5 of the infrared transparent disk are metallic and highly reflective, so that they only slightly absorb radiative heat flux. Thus the error in the convective heat flux measurement caused by absorption of radiation at the front surface 5 of the infrared transparent disk 3 is very small. The partial reflection of radiative heat flux by these thin films only slightly reduces the sensitivity of the total heat flux sensor. This is equivalent to a small reduction in the effective aperture and may be fully compensated for in calibration.

The error in the convective heat flux indication caused by absorption of radiation outside the passband of the infrared transparent layer 3 is also small because absorption takes place throughout the thickness of the layer. Thus the front surface and the back surface of the infrared transparent layer are heated almost equally, resulting in little or no increase in the indicated convective heat flux.

In the preferred embodiment of the invention, thermocouple compensation is not needed because all potentials are sensed on copper electrodes. Electrical noise pickup is minimized by this and by the balanced layout of the electrical circuits

### Alternative Embodiments of the Invention

The invention is not limited to the preferred embodiment of this disclosure, but may be practiced in many alternative embodiments. For example, a novel and useful convective heat flux sensor may be produced by utilizing a subset of the laminated assembly 2. Referring to FIG. 2, if the infrared transparent layer 3, with its thermocouples 6 and 7, is applied directly to a surface coated for infrared absorption, it will indicate only convective heat flux. Instead of being absorbed in a separate infrared absorbing layer, radiant energy will pass through the infrared transparent layer 3 and be absorbed at the surface without creating a temperature drop across the infrared transparent layer 3. The advantage of this sensor over a conventional convective sensor made of a total heat flux sensor coated with reflective paint is that radiant energy is absorbed by the sensor in the same manner as it is absorbed elsewhere on the surface. An error that might be caused by a different rise in temperature at the sensor, compared to the rest of the surface, is thereby minimized. Referring to FIG. 1, the alternative convective sensor comprises the infrared transparent layer 3, thermocouples 6 and 7 with their leads 14, 15, 16 and 17, and differential amplifier 9.

Other alternative embodiments of the invention may be produced by selecting different materials for its construction. For example, the infrared transparent disk 3 may be made of quartz, sapphire, calcium fluoride, magnesium fluoride or zinc selenide, or an acrylic polymer with good infrared transmission properties. The infrared absorbing disk may be made of any black plastic, or a layer of black paint may be applied between the infrared transparent disk 3 and a disk 4 of any thermally stable solid material. In the preferred embodiment, copper-constantan thermocouples are used because they produce a relatively high output potential of 39 microvolts/° C. temperature difference. Thermocouples of any type may be substituted for copper-constantan, for example platinum-platinum/rhodium, iron-constantan or nickel-nichrome. In general, other types have a lower output potential but a wider temperature range. The thermocouples may be thin film, foil or wire, although thin films produce the least disturbance to heat flow and the smallest resulting error.

Thicknesses of the infrared transparent disk 3 and infrared absorbing disk 4 will affect the respective sensitivity of the sensor to convective and total heat flux. A thicker disk will produce a greater temperature drop from a given heat flux, but this will magnify the disturbance and error caused by insertion of the sensor into the path of heat flow. Thinner disks will reduce this error, but the sensor sensitivity will be reduced. Thicknesses of the disks will also affect the response time of the invention, with thicker disks reacting more slowly to changes in heat flux. Dimensions of the invention may be chosen to achieve a desirable compromise among the objectives of high sensitivity, fast response and error caused by installation of the sensor.

If the source of radiation is at a higher color temperature and produces visible or ultraviolet light, a disk that is transparent to these wavelengths may be substituted for the infrared transparent disk 3 of the invention. In general the material of the transparent disk 3 should be chosen for minimum net absorption of the expected radiative heat flux.

The choice of materials for the different parts of the sensor of the invention can be made with different operating temperature ranges in mind. For example, for very high temperature heat flux measurements, single crystals or ceramics may be used for all parts, and the cost of sensors will be relatively high. For applications in industrial ovens such as in bakeries, less expensive but premium quality plastic elements may suffice. For architectural and laboratory applications where temperatures do not exceed about 30° C., less expensive plastic elements may be used .for all parts.

The disks comprising the sensor may be circular, square, or shaped to fit mounting or other mechanical requirements of an application. Connections between the thermocouples and amplifiers may be achieved by soldering, welding, mechanical pressure, or any other method that effectively transmits their potentials to the amplifiers.

A heat flux sensor such as the Vatell Corporation BF series may be substituted for the infrared absorbing disk 3 of the preferred embodiment. This commercial thermopile type sensor has a black infrared absorbent coating on its upper face, and produces a voltage proportional to total heat flux. Thermocouples are still needed on the exposed face of the infrared transparent disk and on the boundary between it and the thermopile type sensor to indicate the temperature drop across the infrared transparent disk for indication of convective heat flux.

The voltage that indicates the temperature difference across the infrared transparent disk 3 may be increased by adding thermocouple pairs on the two sides of the disk and connecting them in series with thermocouple 6.

In the preferred embodiment the heat sinking surface to which the sensor is attached is made of copper, and is cooled by water flow through internal passages. An alternative for short duration measurements would be a copper block having sufficient mass to prevent significant temperature rise during the measurements. Instead of copper, the heat sinking surface may be made of nickel or any other material with high thermal conductivity.

In some applications it may be desirable to indicate the heat flux delivered to or removed from an object whose temperature is not controlled, for example in measuring the response of a product to a heating or cooling process. To perform this function the sensor of the invention would be attached to the product itself, or to another object whose thermal properties model those of the product. The sensor will indicate the correct values of convective and radiative heat flux in these applications aas well.

In the preferred embodiment of the invention, potentials of the thermocouple pairs are sensed differentially on their copper electrodes. An alternative construction would be to separately indicate each of the three temperatures, using thermocouple amplifiers with cold junction compensation. The three temperature indications would then be used to calculate convective, radiative and total heat fluxes, using the known thermal properties of the two layers of the assembly. This arrangement is less desirable because it is more complex, and accuracy depends on more elements.

The magnitude of the convective heat transfer signal may be increased by series connecting multiple thermocouple pairs across the infrared transparent layer. This can be done by depositing thin film traces of copper and constantan on the edges of the disk to interconnect thermocouple pairs around the outer rim of the infrared transmitting disk. While more complex, this arrangement can increase the signal potential by a factor of 10 or more without increasing the noise level.

The total heat flux sensor can be a conventional unit such as the Vatell Corporation BF sensor, which produces a large output signal indicative of total heat flux. In this case the layer of infrared transparent material will be attached directly to the front surface of the BF sensor.

Other types of temperature sensors may be substituted for the thermocouples of the preferred embodiment. For example, the sensors may be thin film resistance temperature detectors (RTD's). These require a small current to energize them, and the amplifier circuits needed for their signal processing are more complex. Even so, there may be circumstances in which RTD's may have an advantage.

### Applications for the Invention

The features of the invention may have particular value in the following applications.

In conveyor ovens for processing food or other articles, it is highly desirable to separately profile convective and radiative heat flux as a function of longitudinal and lateral position in the oven. The invention can be used for this purpose in conjunction with a tracking or recording device. No compensating delay for physical separation of the convective and radiative sensors is needed, and the physical position of the two measurements will always be exactly the same.

A common objective in fire research is to understand whether a fire propagates by radiative or convective heat transfer. The invention can provide accurate and useful information for this research, particularly in the instrumentation of test fires.

It may be useful in architectural heating, ventilation and air conditioning control to have separate values for solar heating and convective cooling. The sensor of the invention could provide this information with high accuracy.

In studies of the effect of fire and other high temperature sources on human skin, it is often useful to separately characterize the radiative and convective effects. With the sensor of the invention this characterization can be done more efficiently.

I claim:

1. A sensor for indicating convective heat flux at the surface of a solid comprising:
a layer of radiation transparent material bonded to said surface;
first temperature sensing means on the outer surface of said layer of radiation transparent material;
second temperature sensing means on the inner surface of said layer of radiation transparent material; and
means for comparing the indications of said first and said second temperature sensing means.

2. The sensor of claim 1 further comprising a radiation absorbing layer between said layer of radiation transparent material and said surface of said solid.

3. The sensor of claim 1 in which said first and said second temperature sensing means are thermocouples.

4. The sensor of claim 1 in which said first and said second temperature sensing means are thin film thermocouples.

5. The sensor of claim 1 in which said means for comparing the indications of said first and said second temperature sensing means is a differential amplifier.

6. A sensor for indicating heat flux at a surface comprising:
a layer of radiation absorbing material bonded to said surface;
a layer of radiation transparent material bonded to said layer of radiation absorbing material;
first temperature sensing means on the outer surface of said layer of radiation transparent material;
second temperature sensing means at the boundary between said layer of radiation absorbing material and said layer of radiation transparent material; and
means for comparing the indications of said first and said second temperature sensing means.

7. The sensor of claim 6 further comprising third temperature sensing means at the boundary between said layer of radiation absorbing material and said surface; and
means for comparing the indications of said second and said third temperature sensing means.

8. The sensor of claim 7 further comprising means for deriving a radiative heat flux indication from said means for comparing the indications of said first and said second temperature sensing means and said means for comparing the indications of said second and said third temperature sensing means.

9. The sensor of claim 6 in which said temperature sensing means are thermocouples.

10. The sensor of claim 7 in which said temperature sensing means are thermocouples.

11. The sensor of claim 8 in which said temperature sensing means are thermocouples.

12. The sensor of claim 6 in which said means for comparing said indications of said first and said second temperature sensing means is a differential amplifier.

13. The sensor of claim 7 in which said means for comparing said indications of said second and said third temperature sensing means is a differential amplifier.

14. The sensor of claim 8 in which said means for deriving a radiative heat flux indication is a differential amplifier.

15. The sensor of claim 6 in which said temperature sensing means are thin film thermocouples.

16. The sensor of claim 7 in which said temperature sensing means are thin film thermocouples

17. The sensor of claim 8 in which said temperature sensing means are thin film thermocouples

18. A method for indicating convective heat flux at a surface consisting of:
applying a first temperature sensing means to one side of a layer of radiation transparent material;
applying a second temperature sensing means to the other side of said layer of radiation transparent material;
bonding said layer of radiation transparent material to the surface; and
comparing indications of said first and said second temperature sensing means.

19. The method of claim 18 in which said temperature sensing means are thermocouples.

20. The method of claim 18 in which said temperature sensing means are thin film thermocouples.
